(19) United States
(12) Patent Application Publication
(10) Pub. No.: US 2012/0274062 A1
(43) Pub. Date: Nov. 1, 2012

(54) PIPE JOINT

(76) Inventors: Toshiyuki Sato, Gamo-gun (JP); Taihei Yokoyama, Gamo-gun (JP)

(21) Appl. No.: 13/060,403

(22) PCT Filed: Aug. 27, 2010
(86) PCT No.: PCT/JP2010/064625

§ 371 Date: Feb. 23, 2011

(51) Int. Cl. F16L 37/08

(52) U.S. Cl. 285/305

(57) ABSTRACT

An object is to provide a pipe joint that enables claw portions 21, which have been biting into the outer circumference of the second pipe 120, to pull out from the outer circumference when locking members 20 are stopped from being pressed by press bolts 30, prevents the locking members 30 from being lost during transportation, and assures the locking members 30 to be sufficiently inclined when an external force in such a direction as to cause the first pipe 110 to be pulled out from the second pipe 120 has been acted on the pipe joint. The pipe joint includes an annular press ring 10 that is mounted around the insertion port 121 of the second pipe 120, the locking members 20 that have claw portions to bite into the outer circumference of the second pipe 120, the press bolts 30 that make the locking members 20 project outward from the inner circumference of the press ring 10, and the elastic members 40 that hold the locking members 20. The press ring 10 includes operational portions 13 having the press portions 11 and the spaces 13d. The elastic members 40 each have elasticity so as to draw the locking member 40 into the space 13d while making the locking member 40 conform to the inclined surface 13f of the space 13d, make the claw portion 21 of the locking member 20 move into and out of the space 13d, and make the locking member 20 to project outward from the space 13d.

### FIELD OF THE INVENTION

The present invention relates to a pipe joint for coupling pipes together, such as water pipes and gas pipes, and more specifically relates to a pipe joint that includes a pressing ring for pressing a sealing fitted between pipes.

### RELATED ART

A variety of pipe joints are provided to fasten two pipes together by inserting an insertion port of one (first) pipe into a receiving port of another pipe (second pipe) while fitting a seal ring between an inner circumference of the receiving port of the first pipe and the insertion port of the second pipe. For example, Patent Document 1 describes the invention regarding a pressing ring (a pipe joint) for pipe joint pull-out prevention that is designed to prevent underground pipes from being destroyed or damaged at a pipe joint portion, even when the underground pipes are subjected to pressure fluctuation in any direction around the pipe axis, by allowing either pipe to tilt.

When a receiving port (referred as the “pipe receiving port” in Patent Document 1,) 111 of one (first) pipe 110 is to be coupled with an insertion port (referred as the “pipe insertion port” in Patent Document 1) 121 of another (second) pipe 120, the pressing ring for pipe joint pull-out prevention has, as shown in FIG. 7, a press ring 101 mounted around the insertion port 121 of the second pipe 120 or a seal ring (referred as the “rubber ring” in Patent Document 1) 102 previously mounted around the inner circumference of the receiving port 111 of the first pipe 110 is provided.

The press ring has a plurality of bolt holes 101a (only one of them is illustrated) disposed at an equal interval mutually, into which press bolts (referred as the “press bolts” in Patent Document 1) are threaded in parallel to the pipe axis of the first pipe 110. Press bolts 103 each have a conically tapered surface 103a at its leading end. The press ring 101 has in its inner circumference a plurality of recesses 101b which communicate with the bolt holes 101a, respectively. The recesses 101b each have a portion close to the receiving port 101b, which portion is formed as an inclined surface 101c, and the opposite portion, which portion is formed as a vertical surface 101d.

Locking members 104 are respectively mounted inside the recesses 101b in such a manner as to be able to be inclined. The locking members 104 each have a claw portion 104a having an arc shape that bites into the outer circumference of the insertion port 121 of the second pipe 120, and a head portion 104b that is pressed by the tapered surface 103a formed at the leading end of the press bolt 103. The head portion 104b of each locking member 104 has a pressure receiving recess (not shown) into which a part of the curved surface of the tapered surface 103a of the press bolt 103 is fitted.

In the press ring for pipe joint pull-out prevention, as shown in FIG. 7(a), at the time immediately after the coupling of the first pipe 110 with the second pipe 120, the locking members 104 each are held in inclined position to conform to the inclined surface 101c and the claws 104a bite into the outer circumference of the insertion port 121 of the second pipe 120 at an inclined angle of a wedge shape.

When the second pipe 120 starts pulling out, according to the pressure application by fastening of the press bolts 103, that is, a slight puffing-out displacement between the first pipe 110 and the second pipe 120, as shown in FIG. 7(b), the locking members 104 are inclined to the position perpendicular to the pipe axis from the inclined position, and cause the claw portions 104a to further bite into the outer circumference of the insertion port 121 within a range not exceeding the perpendicular direction.

### PRIOR ART DOCUMENTS

### Patent Documents

Patent Document 1: Japanese Patent No. 4372129

### DISCLOSURE OF THE INVENTION

### Problems to be Solved by the Invention

The press ring for pipe joint pull-out prevention disclosed in Patent Document 1 is structured to cause only the claw portions 104a of the locking members 104 to bite into the outer circumference of the insertion port 121 by fastening the press bolts 103. Accordingly, even when the press bolts 103 are loosened to dismantle the first pipe 110 and the second pipe 120, the claw portions 104a of the locking members 104 are not pulled out from the insertion portion 121. That is, the first pipe 110 and the second pipe 120 cannot be dismantled.

Also, according to the press ring for pipe joint pull-out prevention disclosed in Patent Document 1, the locking members 104 are merely placed within the recesses 101b of the press ring 101, and therefore, during transportation to the actual site to fasten two pipes together, the locking members 104 placed within the recesses 101b may fall off and be lost. Also, there is a case where the locking members 104 are temporarily fixed to the downwardly facing surfaces of the recesses 101b by a double stick tape or the like in order to prevent falling off of the locking members 104 from the inside of the recesses 101b. However, the temporarily fixed locking members 104 may lose their falling-off prevention ability as a result o peeling off of the double stick tape due to fastening action of the press bolts 103, which poses the difficulty in operation check after assembling or reinstallation of the pipe joint.

Furthermore, the press ring for pipe joint pull-out prevention disclosed in Patent Document 1 causes the claw portions 104a of the locking members 104 placed inside the recesses 101b to bite into the second pipe 120 at an inclined angle. Thus, the locking members 104 each must hold its inclined position which conform to the inclined surface 101c of the recess 101b. Therefore, a relatively thick spacer (not shown) is interposed between each locking member 104 and the perpendicular surface 101d.

Since the spacers each maintain a given distance between the locking member 104 and the perpendicular surface 101d, they block the bolts 103 from moving in conformity with the inclined surfaces 101c when the bolts 103 have been operated. Also, since the spacers make it impossible to assure the locking members 104 to be inclined sufficiently within a range of the recesses 101b, the claw portions 104a may not sufficiently bite into the outer circumference of the insertion port 121, when the second pipe 120 starts pulling out of the pipe joint.

Accordingly, it is an object of the present invention to provide a pipe joint that enables claw portions, which have been biting into the outer circumference of the second pipe, to pull out from the outer circumference when locking members are stopped from being pressed by press bolts, prevents the locking members from being lost during transportation, and assures the locking members to be sufficiently inclined when an external force in such a direction as to cause the first pipe to be pulled out from the second pipe has been acted on the pipe joint.

### Means for Solving Problems

According to the present invention, there is provided a pipe joint for fastening a first pipe and a second pipe together while sealing therebetween by inserting an insertion port of the second pipe into a receiving port of the first pipe, and, at the time of insertion, pressing a seal ring, which has been fitted between the inner circumference of the receiving port of the first pipe and the outer circumference of the insertion port of the second pipe, toward the inside of the receiving port of the first pipe, wherein the first pipe includes an outwardly oriented flange portion disposed around an opening edge of the receiving port and a plurality of fastening portions disposed on the flange portion at a predetermined interval mutually; the pipe joint further comprising:
an annular press ring mounted around the insertion port of the second pipe, locking members having claw portions that bite into the outer circumference of the second pipe, press bolts that make the locking members project from the inner circumference of the press ring, and elastic members that hold the locking members;
the press ring including an annular press portion, against which the surface of the seal ring facing the annular press portion is pressed, a plurality of fastening portions that are disposed respectively facing the fastening portions of the first pipe and are respectively fastened to the fastening portions of the first pipe by fastening devices, and operational portions disposed adjacent to the fastening portions of the press ring;
each of the operational portions including a shaft shaped portion that has an inwardly threaded portion extending in a direction along the second pipe, and a space that is disposed to communicate with the inwardly threaded portion at a portion between the shaft shaped portion and the press portion, the space being defined by a perpendicular surface disposed close to the shaft shaped portion and oriented perpendicularly relative to the outer circumference of the second pipe, and an inclined surface disposed close to the press portion and inclined relative to the perpendicular surface so as to make an opening side of the space wide and an inner side thereof narrow;
each of the press bolts including a shaft portion that is brought into a threaded engagement with the inwardly threaded portion of the press ring, and a tapered portion that has a conical shape projecting from a leading end of the shaft portion and located within the space;
the locking members being placed in the spaces, and each of the locking members having a head portion that is disposed on the side opposite to the claw portion and is brought into abutting engagement with the tapered portion of each of the press bolts; and
each of the elastic members having elasticity so as to draw the locking member into the space while making the locking member conform to the inclined surface of the space, make the claw portion of the locking member move into and out of the space, and make the press ring hold the locking member to enable the locking member to project outward from the space.

According to the above pipe joint, in summary, the locking members are placed in the spaces of the operational portions provided in the press ring, and these locking members are drawn into the spaces to conform to the inclined surfaces of the spaces by the elastic members, so that not only the claw portions of the locking members are movable into and out of the spaces, but also the locking members can be prevented from being lost during transportation or the like of the pipe joint.

Then, by fastening the press bolts and pressing the head portions of the locking members through the tapered portions of the press bolts, the claw portions of the locking members project outward from the spaces to bite into the outer circumference of the second pipe. When the coupled two pipes are to be dismantled, the press bolts are loosened to stop the locking members from being pressed. Thus, the locking members are drawn into the inner side of the spaces so as to be pulled out of the insertion port of the second pipe, into which the claws have bitten. A series of these actions are performed along the inclined surfaces.

In the pipe joint of the present invention, the elastic members are preferably annular elastic members, cutouts for holding each of the elastic member are formed in opposite surfaces of each of the locking members, and a groove for holding each of the elastic members is formed in each of the operational portions of the press ring.

According to this pipe joint, in which the elastic members are annular elastic members, assembling can be achieved by simple elastic members. And, the elastic members each are held in the cutouts formed in the opposite surfaces of each locking member and the groove formed in each operational portion so that they cannot be removed.

In the pipe joint of the present invention, a groove for fittingly receiving each of the elastic members is preferably formed in a front surface of each of the locking members, the front surface facing the perpendicular surface of the space.

According to this pipe joint, the groove for fittingly receiving each of the elastic members, which is formed in the front surface of each of the locking members, the front surface facing the perpendicular surface of the space, eliminates interposition of the elastic member between the front surface of the locking member and the perpendicular surface, and therefore enables the locking member to be inclined within an inclined range up to the fully perpendicular position relative to the insertion port of the second pipe, when the locking member is brought into an upright position along the perpendicular surface from the inclined position along the inclined surface of the space.

### Advantages of the Invention

According to the present invention, the pipe joint as provided, in which the locking members are placed in the spaces provided in the press ring, and the locking members are drawn into the spaces by the elastic members, can prevent lost of the locking members, as well as enables the locking members to be inclined within an inclined range up to the perpendicular position, when one of the pipes is about to be pulled out from another pipe.

### BRIEF DESCRIPTION OF THE DRAWINGS

FIG. 1 is a partially exploded perspective view showing a pipe joint of one embodiment of the present invention.

FIG. 2 show a press ring of a pipe joint of one embodiment of the present invention, in which FIG. 2(a) is a perspective view shown from the front side, and FIG. 2(b) is a perspective view shown from the rear side.

FIG. 3 show a press ring of a pipe joint of one embodiment of the present invention, in which FIG. 3(a) is a front view, FIG. 3(b) is a side view and FIG. 3(c) is a rear view.

FIG. 4 is a cross sectional side view showing two pipes of one embodiment in a state where they have been coupled together by a pipe joint of the present invention but yet not fastened together.

FIG. 5 is a cross sectional side view showing two pipes of one embodiment in a state where they have been coupled and tightened together by a pipe joint of the present invention.

FIG. 6 is a cross sectional side view showing two pipes of one embodiment in a state where they have been fastened together and subjected to a force causing the two pipes to be separated from each other.

FIG. 7 show one example of a conventional pipe joint (press ring for pipe joint pull-out prevention), in which FIG. 7(a) is a cross sectional side view when pipes are fastened together, and FIG. 7(b) is a cross sectional side view when pipes start to be pulled out.

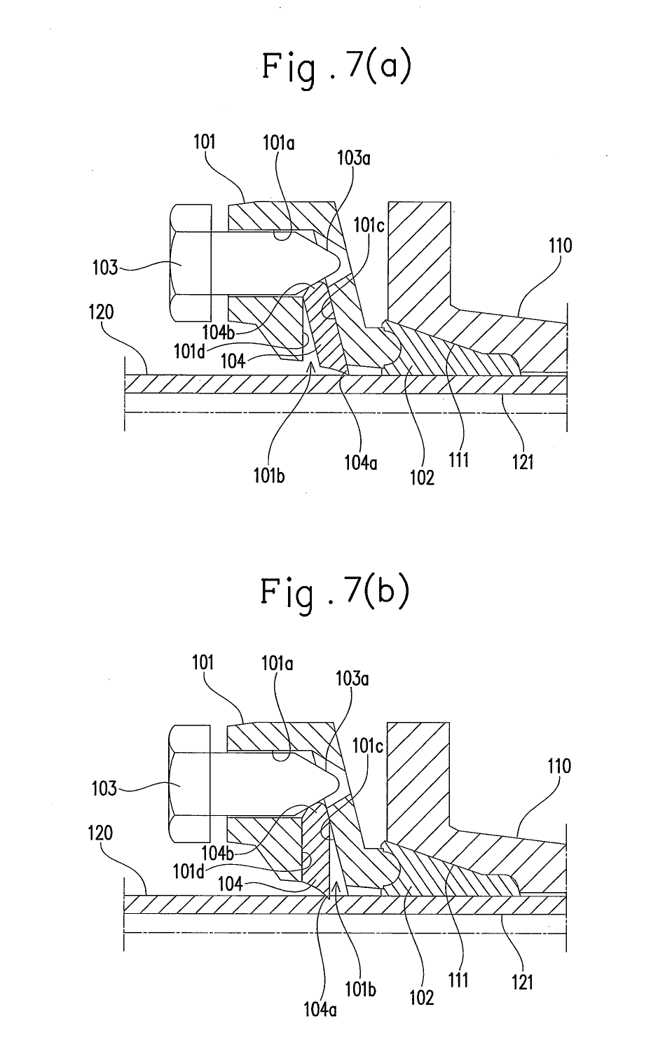

### DETAILED DESCRIPTION OF THE PREFERRED EMBODIMENT

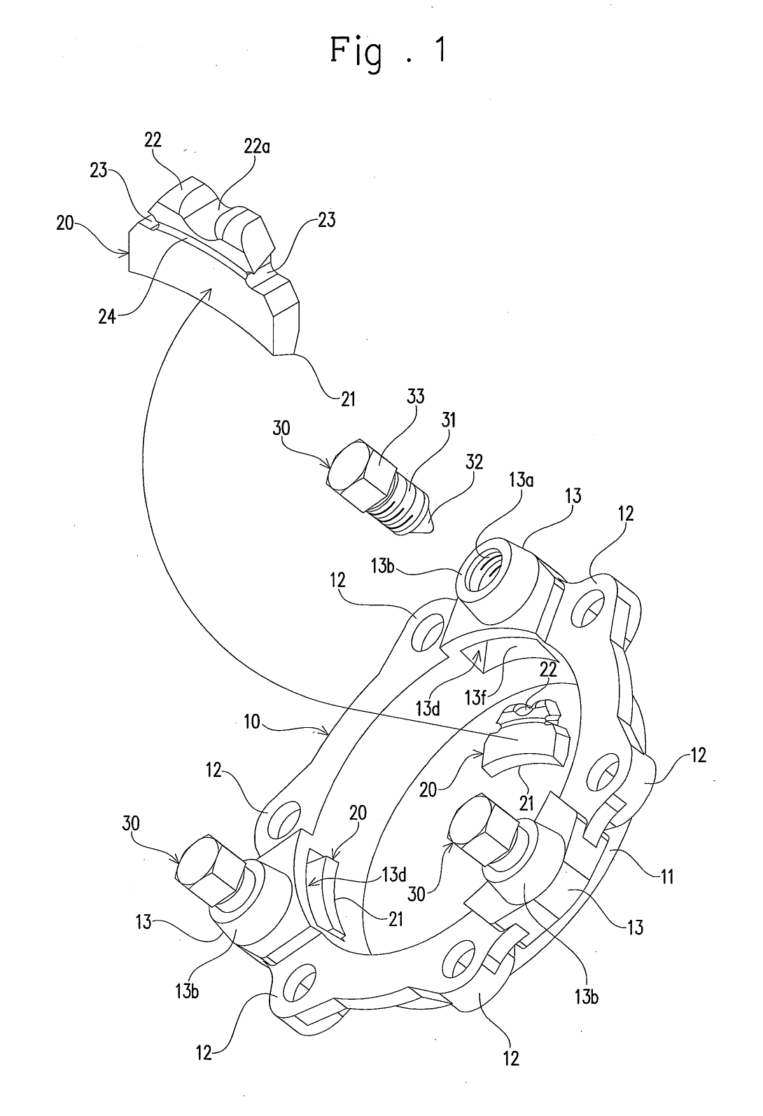

Now, the description will be made for a pipe joint according to one embodiment of the present invention with reference to FIGS. 1 to 6. This pipe joint is so structured that one pipe (hereinafter referred to as “first pipe”) 110 has a receiving port 111 and another pipe (hereinafter referred to as “second pipe”) 120 has an insertion port 121, and a seal ring 102 is fitted between an inner circumference of the receiving port 111 of the first pipe 110 and an outer circumference of the insertion port 121 of the second pipe 120, in which the insertion port 121 of the second pipe 120 is inserted into the receiving port 111 of the first pipe 110 and the seal ring 102 is pressed toward the inner side of the receiving port 111, thereby fastening the first pipe 110 and the second pipe 120 together in sealed conditions.

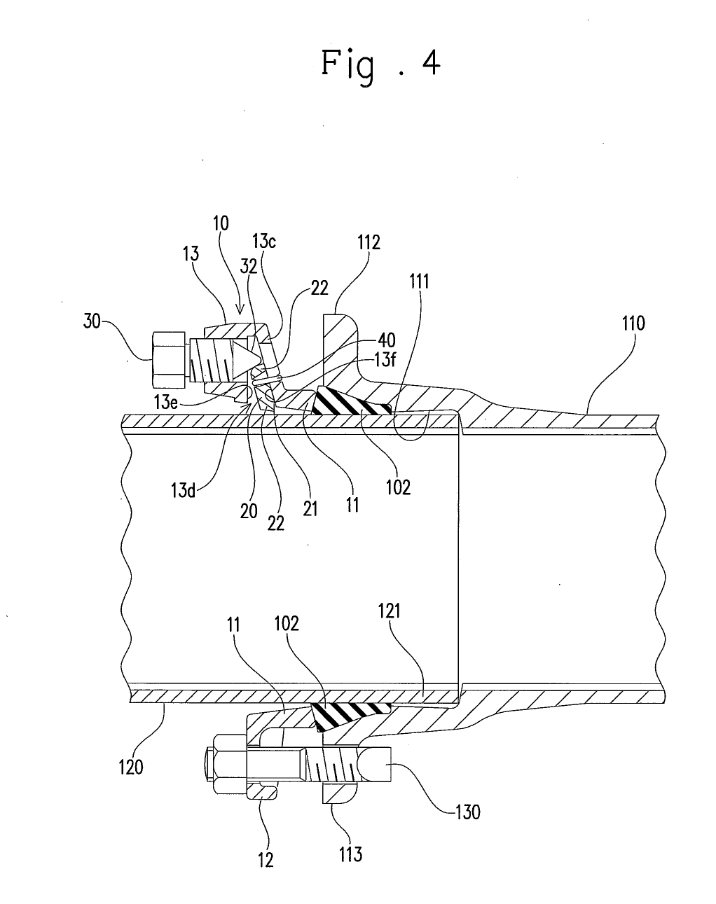

As shown in FIGS. 4 to 6, the first pipe 110 has an outwardly oriented flange portion 112 around an opening edge of the receiving port 111, and has fastening portions 113 in the flange portion 112 at a predetermined interval mutually. The fastening portions 113 are generally portions each having an inwardly threaded portion into which a fastening bolt 130 as a fastening device is to be threaded, and may be portions each having a through-hole, through which fastening is achieved by a fastening bolt 130 and a nut which fastens the bolt 130. These fastening portions 113 are provided in one pair or in plural pairs (only one of them is illustrated herein).

As shown in FIGS. 1, 4 and 6, the pipe joint has a press ring 10 mounted around the insertion port 121 of the second pipe 120, locking members 20 each having a claw portion 21 that bites into an outer circumference of the second pipe 120, press bolts 30 that each make the corresponding locking member 20 project from the inner circumference of the press ring 10, and elastic members 40 that each hold the corresponding locking member 20.

For the elastic members 40, elastic annular members, such as expandable O-rings, are used.

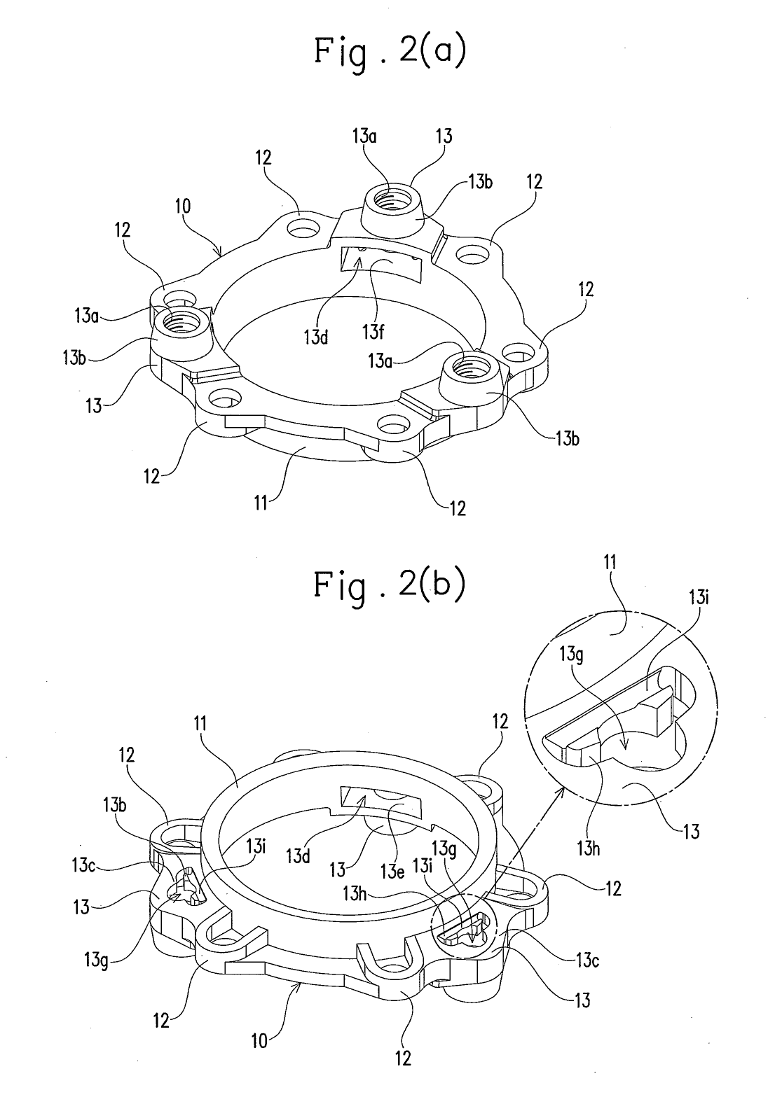

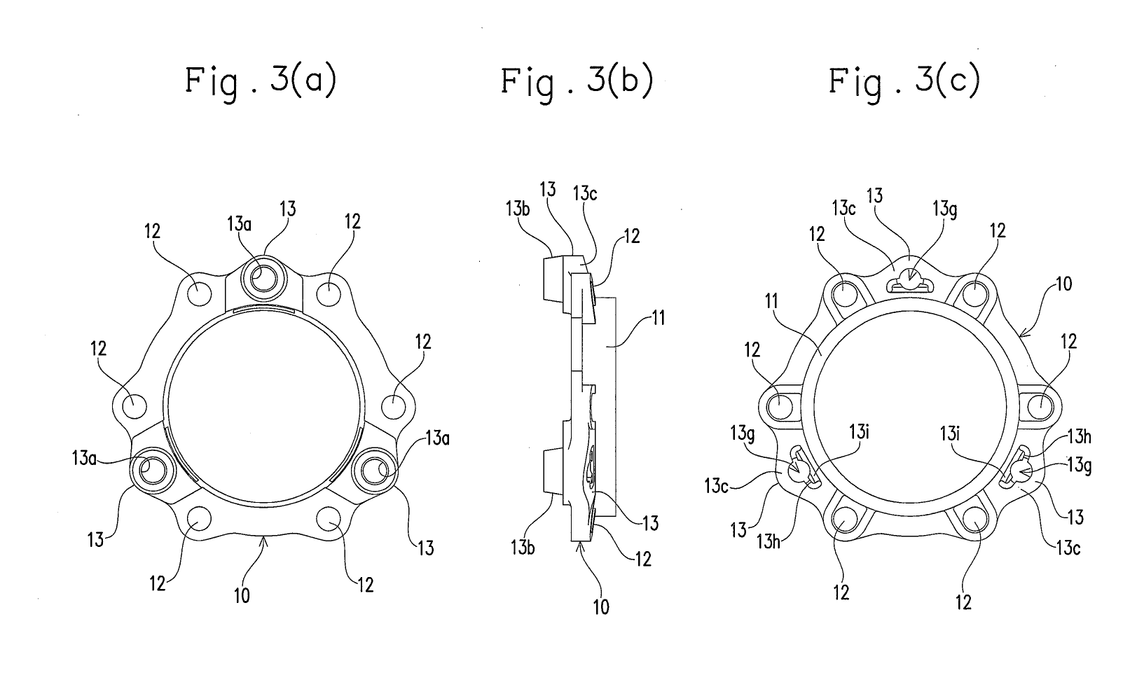

As shown in FIGS. 2 and 3, the press ring 10 has an annular press portion 11 on the rear side (the side facing the receiving port 111 of the first pipe 110), against which the surface of the seal ring 102 facing the annular press portion is pressed, a plurality of fastening portions 12 that are disposed respectively facing the fastening portions 113 of the first pipe 110, and operational portions 13 disposed adjacent to the fastening portions 12, respectively. When the first pipe 110 has the fastening portions 113 disposed in plural pairs, the fastening portions 12 of the press ring 10 are also disposed in pair at one site and in plural pairs in total (three pairs in Figures). The fastening portions 12 of the press ring 10 are formed as through-holes, through which the fastening bolts 130 are extended.

The operational portions 13 each are disposed between every pair of the fastening portions 12. These operational portions 13 each include a shaft shaped portion 13b that has an inwardly threaded portion 13a extending in a direction along the second pipe 120, a support portion 13c that covers an inner end of the inwardly threaded portion 13a with a space therefrom and that extends continuously to the press portion 11, and a space 13d that is disposed to communicate with the inwardly threaded portion 13a at a portion between the shaft shaped portion 13b and the press portion 11.

The shaft shaped portion 13b is disposed on the front side, which does not face the annular press portion 11. The space 13d has an inclined shape by a perpendicular surface 13e disposed close to the shaft shaped portion 13b, which is perpendicularly oriented relative to the outer circumference of the second pipe 120, and an inclined surface 13f, which is an inner surface of an inclined portion of the support portion 13c. This space 13d has an opening side (a portion facing the outer circumference of the second pipe 120), and an inner side (a portion extending continuously to the inwardly threaded portion 13a), in which the space 13d gradually increases in width from the inner side toward the opening side.

As shown in FIGS. 2(b) and 3(c), at the center of the support portion 13c is formed an opening 13g, into which a detent portion 13h projects. On the back side (a side facing the flange portion 112 of the first pipe 110) of the detent portion 13h along the entire width is formed a groove 13i. With the opening 13g, the elastic member 40 such as an O-ring can be held at the detent portion 13h and more specifically the elastic member 40 is fitted into the groove 13i of the detent portion 13h so as to be prevented from dropping off from the detent portion 13h.

As shown in FIG. 1, the press bolts 30 each have a shaft portion 31 having an outwardly threaded portion which is threaded into the inwardly threaded portion 13a of the press ring 10, a tapered portion 32 that has a conical shape projecting from a leading end of the shaft portion 31 and located within the space 13d, and a head portion 33 disposed at a base end of the shaft portion 31.

As shown in FIG. 1, the locking member 20 has a small strip shape that is placed within the space 13d, and has a head portion 22 that is brought into abutting engagement with the tapered portion 32 of the press bolt 30 on the side opposite to the claw portion 21 that bites into the outer circumference of the second pipe 120. In order to achieve surface-to-surface contact between the head portion 22 and the tapered portion 32 of the press bolt 30, the head portion 22 is provided with a circular recess 22a. This recess 22a is not essential and alternatively the head portion 22 may be formed with a flat surface. The claw portion 21 is formed into a circular shape conforming to the outer circumference of the second pipe 120, and has a tapered knife-edge shape.

The locking member 20 is held to the support portion 13c so as to conform to the inclined surface 13f of the space 13d by the elastic member 40, and the claw portion 21 projects outward from the space 13d by pressing the head portion 22 through the tapered portion 32 of the press bolt 30. On the opposite side surfaces of the locking member 20 are formed cutouts 23 for holding the elastic member 40, such as an O-ring. Furthermore, on the front side (the side facing the shaft shaped portion 13b) of the locking member 20 is formed a groove 24 for fittingly receiving the elastic member 40, such as an O-ring. The elastic member 40 is fitted into the groove 24 so as to be prevented from protruding toward the front side of the locking member 20.

Now, the description will be made for the fastening method and the manner of use of the thus structured pipe joint with reference to FIGS. 4 to 6. In this pipe joint, since the locking members 20 are held to the detent portions 13h of the press ring 10 by the elastic members 40, they are not likely to be lost when in transportation or the like.

The press bolts 30 are held loosened and the locking members 20 are held in inclined position so as to each conform to the inclined surface 13f of the space 13d by the elastic member 40 in a state prior to fastening of the pipe joint, as shown in FIG. 4, in which the insertion port 121 of the second pipe 120 is inserted into the receiving port 111 of the first pipe 110; the seal ring 102 is fitted between the inner circumference of the receiving port 111 of the first pipe 110 and the outer circumference of the insertion port 121 of the second pipe 120; and, under this state, the fastening bolts 130 are fastened to the fastening portions 113 of the first pipe 110 through the through-holes of the press ring 10.

At this moment, the claw portions 21 of the locking members 20 are retracted into the spaces 13d, respectively. Whilst, the annular press portion 11 of the press ring 10 is held in abutting engagement with the surface of the seal ring 102 facing the annular press portion.

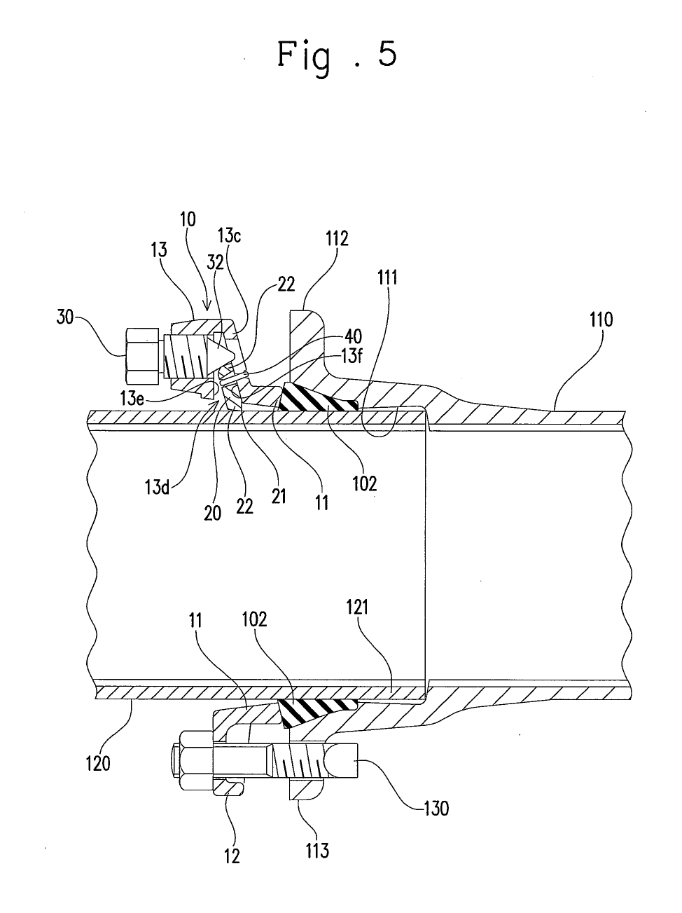

As shown in FIG. 5, when the press bolts 30 are fastened to fasten the pipe joint, the tapered portion 32 of each press bolt 30 is brought into abutting engagement with the head portion 22 of the locking member 20, and thereby presses the locking member 20 toward the outer circumference of the second pipe 120, which causes the claw portion 21 of the locking member 20 to bite into the outer circumference of the second pipe 120. Thus, the fastening of the pipe joint is completed. At this moment, the locking members 20 are held in inclined position conforming to the inclined surfaces 13f of the space 13d.

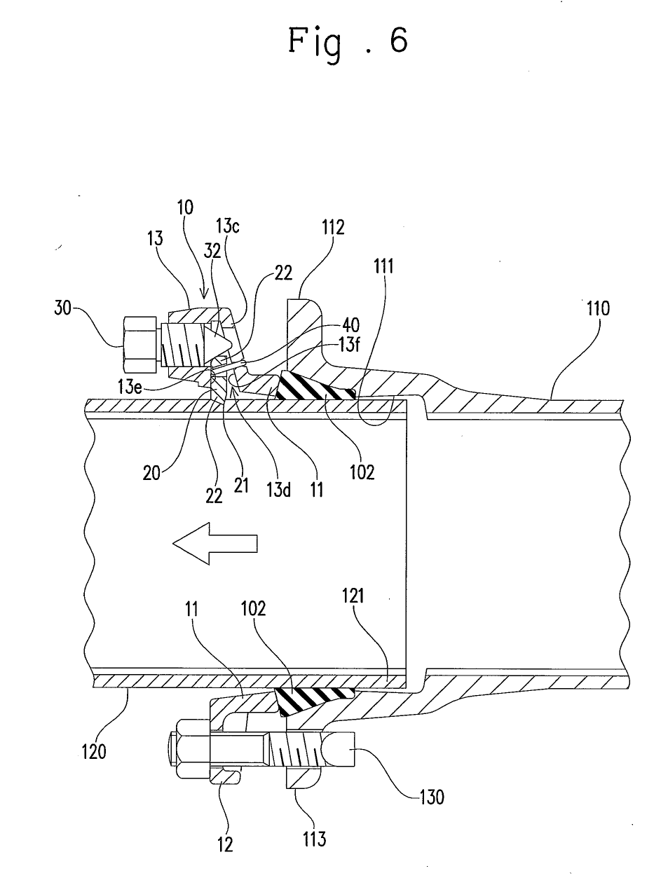

When an external force due to, such as the earthquake in such a direction as to separate the first pipe 110 and the second pipe 120 away from each other is applied to, as shown in FIG. 6, the elastic members 40 are elongated and the locking members 20 are brought into a perpendicular position conforming to the perpendicular surfaces 13e of the spaces 13d, since the claw portions 21 of the locking members 20 have been being bitten into the outer circumference of the second pipe 120. At this moment, since the elastic members 40 are fitted into the grooves 24 formed in the front surfaces of the locking members 20, they are unlikely to become obstacles, enabling the locking members 20 to tightly contact the perpendicular surfaces 13e. However, the locking members 20 may not tightly contact the perpendicular surfaces 13e, but may be held in a substantially upright position.

Although not illustrated, when the first pipe 110 and the second pipe 120 are to be dismantled, the press bolts 30 are loosened. Since the locking members 20 are not pressed any more through the tapered portions 32 of the press bolts 30, they are pulled by the elastic members 40 and the claw portions 21 are pulled out from the outer circumference of the second pipe 120. Thus, this pipe joint can be easily removed from the second pipe 120.

The present invention is not necessarily limited to the above embodiments and may be subjected to various modifications. For example, for the elastic members 40, annular elastic members may be replaced with tension springs. In this case, the openings 13g are not be provided in the support portions 13c, and the detent portions 13h are provided to hold the ends of the tension springs. The grooves 24 for fittingly receiving the elastic members 40 are not necessarily provided in the front surfaces of the locking members 20. Also, the fastening devices 130 may be replaced with any devices other than the fastening bolts.

### DESCRIPTION OF THE REFERENCE NUMERALS

10: press ring, 11: press portion, 12: fastening portion, 13: operational portion, 13a: inwardly threaded portion, 13b: shaft shaped portion, 13d: space, 13e: perpendicular surface, 13f: inclined surface, 13i: groove, 20: locking member, 21: claw portion, 22: head portion, 23: cutout, 24: groove, 30: press bolt, 31: shaft portion, 32: tapered portion, 40: elastic member, 110: one pipe (first pipe), 111: receiving port, 112: flange portion, 113: fastening portion, 120: another pipe (second pipe), 121: insertion port, 130: fastening device (fastening bolt)

1. A pipe joint for fastening a first pipe and a second pipe together while sealing therebetween by inserting an insertion port of the second pipe into a receiving port of the first pipe, and, at the time of insertion, pressing a seal ring, which has been fitted between the inner circumference of the receiving port of the first pipe and the outer circumference of the insertion port of the second pipe, toward the inside of the receiving port of the first pipe, wherein the first pipe includes an outwardly oriented flange portion disposed around an opening edge of the receiving port and a plurality of fastening portions disposed on the flange portion at a predetermined interval mutually; the pipe joint further comprising:
an annular press ring mounted around the insertion port of the second pipe, locking members having claw portions that bite into the outer circumference of the second pipe, press bolts that make the locking members project from the inner circumference of the press ring, and elastic members that hold the locking members;
the press ring including an annular press portion, against which the surface of the seal ring facing the annular press portion is pressed, a plurality of fastening portions that are disposed respectively facing the fastening portions of the first pipe and are respectively fastened to the fastening portions of the first pipe by fastening devices, and operational portions disposed adjacent to the fastening portions of the press ring;
each of the operational portions including a shaft shaped portion that has an inwardly threaded portion extending in a direction along the second pipe, and a space that is disposed to communicate with the inwardly threaded portion at a portion between the shaft shaped portion and the press portion, the space being defined by a perpendicular surface disposed close to the shaft shaped portion and oriented perpendicularly relative to the outer circumference of the second pipe, and an inclined surface disposed close to the press portion and inclined relative to the perpendicular surface so as to make an opening side of the space wide and an inner side thereof narrow;
each of the press bolts including a shaft portion that is brought into a threaded engagement with the inwardly threaded portion of the press ring, and a tapered portion that has a conical shape projecting from a leading end of the shaft portion and located within the space;
the locking members being placed in the spaces, and each of the locking members having a head portion that is disposed on the side opposite to the claw portion and is brought into abutting engagement with the tapered portion of each of the press bolts; and
each of the elastic members having elasticity so as to draw the locking member into the space while making the locking member conform to the inclined surface of the space, make the claw portion of the locking member move into and out of the space, and make the press ring hold the locking member to enable the locking member to project outward from the space.

2. The pipe joint according to claim 1, wherein the elastic members are annular elastic members, cutouts for holding each of the elastic member are formed in opposite surfaces of each of the locking members, and a groove for holding each of the elastic members is formed in each of the operational portions of the press ring.

3. The pipe joint according to claim 2, wherein a groove for fittingly receiving each of the elastic members is preferably formed in a front surface of each of the locking members, the front surface facing the perpendicular surface of the space.
